(19) United States
(12) Patent Application Publication
(10) Pub. No.: US 2004/0148238 A1
(43) Pub. Date: Jul. 29, 2004

(54) System and method for providing a one-time payment to secure the rights to a domain name

(75) Inventors: Blake Bookstaff, Knoxville, TN (US); Vincent A. Claude, Orlando, FL (US); William J. Marquez, Longwood, FL (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: North American Internet, LLC, Orlando, FL

(21) Appl. No.: 10/715,463

(22) Filed: Nov. 19, 2003

Related U.S. Application Data
(60) Provisional application No. 60/427,183, filed on Nov. 19, 2002.

(51) Int. Cl. G06F 17/60

(52) U.S. Cl. 705/35

(57) ABSTRACT

Disclosed are exemplary techniques for securing rights to a domain name for an extended time period. A customer provides domain registration information and a one-time registration payment to a registrar. The registrar may invest at least a portion of the one-time registration payment and use at least a portion of the return on the investment to pay for subsequent registrations of the domain name with a domain name registry so that the domain name remains registered to the customer for the time period requested and paid for by the customer. Any portion of the investment returns in excess of the registry payment made to the domain name registry may be reinvested, disbursed as profit, or a combination thereof.

### CROSS-REFERENCE TO RELATED APPLICATION

The present invention claims benefit of U.S. Provisional Application No. 60/247,183, entitled “System and Method for Providing a One Time Payment to Secure a Domain Name,” filed Nov. 19, 2002, the entirety of which is hereby incorporated by reference herein.

### FIELD OF THE INVENTION

The present invention relates generally to domain name registration and more particularly to domain name registration for an extended time period.

### BACKGROUND OF THE INVENTION

A domain name is an alphanumerical string used as an easily remembered mnemonic for an Internet Protocol (IP) address on the Internet or other IP-based network. When a domain name is entered via a web browser, for example, a domain name system (DNS) process is initiated to convert the domain name to the corresponding IP address. To illustrate, after a user provides the domain name “www.intemic.net” to a web browser to access an associated web page, the web browser typically must identify the corresponding IP address (e.g., 207.151.159.3) before the web browser may obtain the web page from the server having the identified IP address.

The domain name system is configured as a hierarchical structure. To prevent multiple domain name registrations for the same domain name, a single central database (i.e., the “registry”) is maintained by a designated entity (e.g., the Internet Corporation for Assigned names and Numbers or ICANN). Each domain (e.g., .com, .net, .biz, etc.) is managed by a Top Level Domain (TLD) server. The relevant portions of the central database are copied to each TLD server on a periodic basis and from these portions each TLD server creates primary routing tables for their respective domains. The routing tables for a given domain then may be used by DNS servers within the domain to provide domain name to IP address translation for networked devices.

In the United States, as well as a number of other countries, domain name registration is available on a first come, first served basis. Conventionally, a person or business acquires rights to an available domain name by conducting a transaction with a domain name registrar. To acquire a domain name from a registrar, a customer seeker typically submits registration data via mail, fax, email or the Internet requesting a specified domain name and providing certain information about the customer. After confirming that the specified domain name is available, the registrar collects payment from the customer and registers the domain name with the registry on behalf of the customer.

Currently, domain names may be reserved for a maximum of only 10 years. This limitation is put into place by the global registry managing the master list of domain names. This limitation is inconvenient for customers as they must remember, or be reminded, to re-register their domain names periodically or they risk losing their rights to their domain names. Further, this limitation has caused considerable competition between registrars to acquire more business by encouraging customers to sign up for new domain names through the registrar and/or transferring their registered domains into the registrar from another registrar in order to secure this customer.

Accordingly, an improved registration process is needed to assist customers in registering domain names for extended periods, to prevent the transfer of established customers and assist the solicitation of new customers through transfers and new registrations.

### SUMMARY OF THE INVENTION

The present invention mitigates or solves the above-identified limitations in known solutions, as well as other unspecified deficiencies in known solutions. A number of advantages associated with the present invention are readily evident to those skilled in the art, including economy of design and resources, transparent operation, cost savings, etc.

In accordance with one embodiment of the present invention, a method for registering a domain name is provided. The method comprises receiving a registration payment from a customer, investing at least a portion of the registration payment, registering a domain name specified by the customer with a domain name registry for a first registration period, and registering the domain name with the domain name registry for at least a second registration period using at least a portion of a return on the investment of at least a portion of the registration payment funds as payment to the domain name registry. At least a portion of the registration payment may be used as payment to the domain name registry for the first registration period. At least a portion of the registration payment is invested in at least one of a stock, a bond, a mutual fund, a certificate of deposit (CD), an annuity, a perpetuity, a precious metal, a real estate holding, a real estate investment trust (REIT), and a venture capital investment. At least a portion of the return on the investment may be reinvested and/or at least a portion of the return on the investment may be disbursed as profit.

In one embodiment, the first registration period and the second registration period each are not more than a maximum registration period allowed by the domain name registry, and a sum of the first registration period and the second registration period is greater than the maximum registration period.

In accordance with another embodiment of the present invention, a method for registering a domain name is provided. The method comprises receiving a registration payment from a customer, investing at least a portion of the registration payment in at least one investment and registering a domain name specified by the customer with a domain name registry for a continuous series of registration periods, wherein payment for registering the domain name with the domain name registry is provided at least in part from an investment return on the at least one investment. The continuous series of registration periods may be perpetual. At least a portion of the registration payment may be used as payment to the domain name registry for the first registration period. At least a portion of the registration payment is invested in at least one of a stock, a bond, a mutual fund, a certificate of deposit (CD), an annuity, a perpetuity, a precious metal, a real estate holding, a real estate investment trust (REIT), and a venture capital investment. At least a portion of the return on the investment may be reinvested and/or at least a portion of the return on the investment may be disbursed as profit.

A value of the registration payment may be based at least in part on an equation:

$$Payment = R + \frac{R + P}{i} + C + A$$

where Payment represents the registration payment, R represents a cost for a renewal of the domain name with the domain name registry, P represents a desired profit for the first renewal period, C represents a cost of acquisition, A represents administrative overhead expenses, and i represents an expected investment return.

Still further features and advantages of the present invention are identified in the ensuing description, with reference to the drawings identified below.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIG. 1 is a schematic diagram illustrating an exemplary domain name registration system in accordance with at least one embodiment of the present invention.

FIG. 2 is a flow diagram illustrating an exemplary domain name registration method in accordance with at least one embodiment of the present invention.

### DETAILED DESCRIPTION OF THE PREFERRED EMBODIMENTS

The following description is intended to convey a thorough understanding of the present invention by providing a number of specific embodiments and details involving domain name registration. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

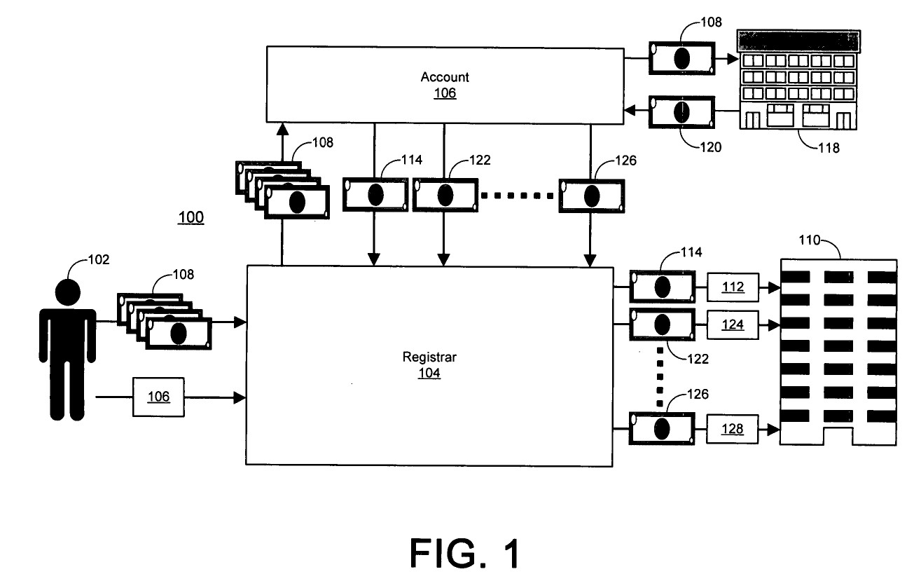

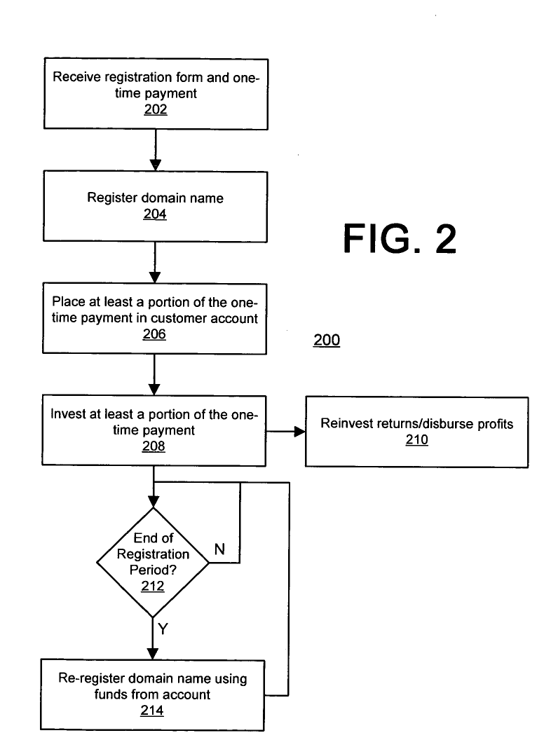

Referring now to FIGS. 1 and 2 an exemplary domain name registration system 100 and method 200 are illustrated in accordance with at least one embodiment of the present invention.

In the illustrated examples of FIGS. 1 and 2 a customer 102 seeking to register one or more domain names initiates a business transaction with a registrar 104 by submitting registration data 106 having domain name registration information for one or more desired domain names to the registrar 104 via mail, email, a web page, etc. After confirming that the requested domain name(s) are available for registration, the registrar 104 may provide the customer 102 with a number of payment options. As with conventional registrars, the registrar 104 may present the customer with the option to pay for only for a first registration period, subject to a maximum registration period as mandated by the domain name registry 110. However, as noted above, this option often inconveniences customers as they must remember to, or be reminded to, re-register at the end of the first registration period. Accordingly, in at least one embodiment, the registrar 104 may provide the customer 102 with the option to make a one-time payment 108 to register the domain name(s) perpetually or for an extended time period (i.e., a time period greater than the maximum registration period set by the global registry), thereby freeing the customer 102 from having to re-register the domain name(s) on a frequent basis, if at all.

After receiving the one-time payment 108 and the registration data 106 at step 202, the registrar 104 may register the indicated domain name(s) with the domain name registry 110 (e.g., the global registry) at step 204 by submitting initial registration data 112 and initial registration payment 114 to the registry 110. The initial registration payment 114 may come from the one-time payment 108 or from a general account maintained by the registrar 104. Moreover, in some instances, the registrar 104 may have a grace period before it is required to pay the registry 110 for registering one or more domain names. In such instances, the registrar may invest the one-time payment 108 and pay a portion or all of the initial registration payment 114 from investment returns at a later date.

The registrar 104 may place at least a portion of the one-time payment 108 into one or more accounts 106 at step 206. The account 106 may include an account specific to the customer 102 or may include a general account used to maintain the funds for a number of customers. In at least one embodiment, the registrar 104 invests at least a portion of the funds of the account 106 with one or more investment opportunities at step 208. The investment opportunities may be provided by one or more financial institutions 118 (e.g., a bank or investment house) and may include, for example, individual stocks or bonds, mutual funds, certificates of deposit (CDs), annuities, perpetuities, precious metals, real estate holdings, real estate investment trusts (REITs), venture capital investments, and the like. The one-time payment 108 may be individually invested or it may be invested together with other funds, such as funds from one-time payments from other customers of the registrar 104.

The returns 120 from the invested portion of the one-time payment 108 may be returned to the account 106 or another account for reinvestment, used to pay for re-registration of the domain name(s) of the customer 102, disbursed as profit to the registrar 104, or a combination thereof, at step 210.

In at least one embodiment, the one-time payment 108 is a dollar sum large enough to allow the registrar 104 to invest the one-time payment 108 and make registration payments to the registry 110 from the returns on the investments of the one-time payment 108, as well as potentially turn a profit from the investments. Accordingly, the dollar value of the one-time payment 108 and the type or types of investment opportunities may be selected in view of the registrar's tolerance for risk and further in view of the registrar's expected profit. To illustrate, should the customer 102 want one or more domain names registered for an extended, but finite, period and if the registrar 104 is more interested in a constant income flow from the invested one-time payment 108, the registrar 104 may choose to invest in, for example, an annuity or CD. Conversely, should the customer 102 want to register one or more domain names in perpetuity, the registrar 104 may choose to invest in, for example, a perpetuity, or stocks, bonds, and the like.

Any of a variety of techniques may be implemented by the registrar 104 to determine an appropriate amount for the one time payment 108 in view of its expected or desired profits and predicted or actual interest rates. To illustrate, EQ. 1 represents an exemplary calculation that may be employed by the registrar 104 to calculate an appropriate value for the one time payment 108 for a perpetual registration of a domain name:

$$Payment = R + \frac{R + P}{i} + C + A \qquad EQ . 1$$

where Payment represents the one time payment 108, R represents the cost for a renewal of a domain name with the registry 110 (e.g., a one year renewal), P represents the desired profit for the first renewal period (e.g., the first year), C represents the cost of acquisition, A represents administrative overhead expenses, and i represents the expected return on the investment (e.g., the interest rate).

For example, assuming a renewal rate of $8 per year, a desired profit of $2 per domain per year, a cost of acquisition of $0.50, an administrative expense of $0.25 and an expected return on the investment of 5%, an appropriate one time payment 108 of $208.75 may be calculated using EQ. 1.

Assuming that payment to the registry 110 is due during the first year of registration, the carry forward of the original one time payment 108 may be calculated as:

Carry_Forward=Payment−C−R−A EQ. 2

and the expected profit on subsequent yearly renewals (P_{subsequent}) may be calculated as:

P_{subsequent}=(Payment−C−R−A)i−R−A EQ. 3

Applying EQ. 3 to the exemplary values from above, the profit for the second and subsequent years is $1.75.

In at least one embodiment, the registrar 104 employs one or more processes to monitor the remaining registration periods for its customers' domain names. After determining that the end of the registration period of the initial domain name registration is approaching at step 212, the registrar 104 may re-register the domain name at step 214 using funds from the account 106. To illustrate, assume that the customer 102 desires to register a domain name for a time period of fifty years and the maximum registration period allowed by the registry 110 is ten years. In this case, the initial registration for the domain name may designate the full ten year period. After the first ten-years have elapsed (step 212), the registrar 104 may withdraw the registry payment 122 necessary to register the domain name for the next ten years from the account 106. The registrar 104 then may forward the registry payment 122 to the registry 110 along with the requisite registration data 124 to re-register the domain name on behalf of the customer 102 (step 214). These steps may be repeated at the end of each registration period, ending in this example with registry payment 126 withdrawn from the account 106 at the end of the 40^{th} year and forwarded to the registry 110 along with registration data 128 to re-register the domain name for the last decade of the 50 year registration desired by the customer 102.

Considering the number of “fly-by-night” domain name registrars and the misinformation surrounding domain name registration procedures, it will be appreciated that some customers may be apprehensive about making a large, lump-sum payment to the registrar 104 without assurance of the credibility of the registrar 104. Accordingly, in at least one embodiment, the registrar 104 may partner with one or more third entities, such as the financial institution 118, to advertise or otherwise promote the one-time payment process described above. In exchange, the registrar 104 may invest a portion or all of the account funds of its customers via the financial institution 118.

Conversely, it will be appreciated that the registrar 104 may make certain investment decisions based on the assumption that the customer 102 will continue to want the registrar 104 to maintain registration for one or more domain names for the agreed-upon registration period. Accordingly, the registrar 104 may bind the customer 102 to an agreement whereby the registrar 104 keeps some or all of the one time payment 108 provided by the customer 102 in the event that the customer 102 decides to terminate the registration of one or more domain names or decides to employ another entity in registering the domain names. Thus, the registrar 104 may make investment decisions with confidence that the funds obtained from the customer 102 will continue to be available for the registrar's use.

As the exemplary system 100 and method 200 demonstrate, a one-time payment by the customer 102 to the registrar 104 benefits both the customer 102 and the registrar 104. The customer 102 conveniently may make a single payment to ensure that a domain name is registered for an extended time period greater than the maximum registration period permitted by the registry 110. The registrar 104 benefits both from the investment returns in excess of the registration costs and by developing a long-term business relationship with the customer 102.

Although the various techniques of the present invention are described above as being performed at least in part by a domain name registrar for ease of illustration, in certain instances, these techniques may be performed in whole or in part by a third party. For example, a third party may receive a one time registration payment from a customer, invest the one time payment, and contract with a conventional registrar to register one or more domain names on behalf of the customer, where payment for the registration is provided by the third party to the conventional registrar from the investment returns. Alternatively, the domain name registry could receive the one time registration payment from a customer to register one or more domain names, invest the registration payment and use a portion of the investment returns to cover the expenses of maintaining the customer's domain name registration at the registry for the designated registration period.

Other embodiments, uses, and advantages of the invention will be apparent to those skilled in the art from consideration of the specification and practice of the invention disclosed herein. The specification and drawings should be considered exemplary only, and the scope of the invention is accordingly intended to be limited only by the following claims and equivalents thereof.

What is claimed is:

1. A method for registering a domain name comprising:
receiving a registration payment from a customer;
investing at least a portion of the registration payment;
registering a domain name specified by the customer with a domain name registry for a first registration period; and
registering the domain name with the domain name registry for at least a second registration period using at least a portion of a return on the investment of at least a portion of the registration payment funds as payment to the domain name registry.

2. The method as in claim 1, wherein at least a portion of the registration payment is used as payment to the domain name registry for the first registration period.

3. The method as in claim 1, wherein the first registration period and the second registration period each are not more than a maximum registration period allowed by the domain name registry, and wherein a sum of the first registration period and the second registration period is greater than the maximum registration period.

4. The method as in claim 1, wherein at least a portion of the return on the investment is reinvested.

5. The method as in claim 1, wherein at least a portion of the return on the investment is disbursed as profit.

6. The method as in claim 1, further comprising advertising via a third party.

7. The method as in claim 1, wherein at least a portion of the registration payment is invested in one of a group consisting of: a stock; a bond; a mutual fund; a certificate of deposit (CD); an annuity; a perpetuity; a precious metal; a real estate holding; a real estate investment trust (REIT); and a venture capital investment.

8. The method as in claim 1, wherein a value of the registration payment is based at least in part on an equation:
$$Payment = R + \frac{R + P}{i} + C + A$$
where Payment represents the registration payment, R represents a cost for a renewal of the domain name with the domain name registry, P represents a desired profit for the first renewal period, C represents a cost of acquisition, A represents administrative overhead expenses, and i represents an expected investment return.

9. A method for registering a domain name comprising:
receiving a registration payment from a customer;
investing at least a portion of the registration payment in at least one investment; and
registering a domain name specified by the customer with a domain name registry for a continuous series of registration periods, wherein payment for registering the domain name with the domain name registry is provided at least in part from an investment return on the at least one investment.

10. The method as in claim 9, further comprising disbursing at least a portion of the investment return as profit.

11. The method as in claim 9, wherein at least a portion of the registration payment is invested in one of a group consisting of: a stock; a bond; a mutual fund; a certificates of deposit (CD); an annuity; a perpetuity; a precious metal; a real estate holding; a real estate investment trust (REIT); and a venture capital investment.

12. The method as in claim 9, wherein the continuous series of registration periods is perpetual.

13. The method as in claim 9, wherein a value of the registration payment is based at least in part on an equation:
$$Payment = R + \frac{R + P}{i} + C + A$$
where Payment represents the registration payment, R represents a cost for a renewal of the domain name with the domain name registry, P represents a desired profit for a first renewal period, C represents a cost of acquisition, A represents administrative overhead expenses, and i represents the investment return.
